(19) United States
(12) Patent Application Publication
(10) Pub. No.: US 2019/0076879 A1
(43) Pub. Date: Mar. 14, 2019

(54) Method for Controlling an Acoustic Warning Device and Acoustic Warning Device That Performs Said Control Method

(71) Applicant: CLARTON HORN, S.A.U., La Carolina (Jaen) (ES)

(72) Inventors: Enrique MINGUET GARCIA, La Carolina (ES); Rafael NICOLAS MARISCAL, La Carolina (Jaen) (ES); Guillermo VACAS ALMAGRO, La Carolina (ES)

(73) Assignee: CLARTON HORN, S.A.U., La Carolina (Jaen) (ES)

(21) Appl. No.: 16/083,212

(22) PCT Filed: Mar. 7, 2017
(86) PCT No.: PCT/ES2017/070126

§ 371 Date: Sep. 7, 2018

(30) Foreign Application Priority Data
Mar. 9, 2016 (ES) P201630274

(51) Int. Cl. B06B 1/02; G08B 3/10; G10K 9/12

(52) U.S. Cl. CPC B06B 1/02; G10K 9/12; G08B 3/10

(57) ABSTRACT

The invention relates to a method which is a more robust, flexible and easy-to-implement alternative to current methods for controlling acoustic warning devices. The method is essentially characterized in that it comprises analyzing and measuring the variation in voltage (U_{L}) of a coil (6) and/or at least one variable property of said voltage (U_{L}), the analysis being performed by a control circuit (10) during the disconnection transient of the coil (6) caused by an electronic switching device (20). The method is further characterized in that it comprises adjusting the frequency and pulse rate of a pulse generator (30) by means of the control circuit (10), where the adjustment is made according to a working condition in which a greater inductance variation is produced in the coil (6), that is, by adjusting the warning device (1) to the resonant frequency thereof.

### OBJECT OF THE INVENTION

The present invention is comprised in the field of audible signaling systems, and more specifically to acoustic warning devices using electric and/or electromagnetic transmission.

The object of the present invention is a method for controlling an acoustic warning device at the resonant frequency thereof, which constitutes a more robust and more efficient alternative when detecting the optimal operating point, and an easier-to-implement alternative with respect to current methods for controlling acoustic warning devices.

### BACKGROUND OF THE INVENTION

Acoustic warning devices (or horns) of the type included in automotive vehicles for emitting an audible signal are well known today. Nevertheless, these acoustic warning devices can also be applied wherever it is necessary to exercise precaution, care, or watchfulness to attract attention in emergency situations, or to urge those who hear it to act in a certain way.

More particularly, acoustic warning devices equipped with an electronic circuit which allow measuring different variables of the warning device to adjust its operating frequency to one referred to as “resonant frequency”, that is, the optimal operating frequency at which maximum efficiency and sound pressure level are achieved, are known.

In that sense, a conventional acoustic warning device (1) such as the one shown in FIG. 1 is based on generating a sound pressure on the basis of the movement of a diaphragm (2) having in its center a metal core better known as a mobile core (3). This movement causes an airflow through a conduit or duct (4) which amplifies it, generating a sound pressure. In the case a disc-shaped acoustic warning device (1), the sound is generated when this mechanical diaphragm (2) moves and the mobile core (3) impacts against the fixed core (5) of the acoustic warning device (1).

To cause that movement of the diaphragm (2), the acoustic warning device (1) has a fixed-position coil (6) through which an electric current is circulated, producing a magnetic field. This magnetic field moves the mobile core (3) in the direction of the axial axis shown in FIG. 1. The relative position of the mobile core (3) with respect to the coil (6) thereby varies, it already being known in the current state of the art that the maximum movement of the mobile core (3) with respect to the coil (6) coincides with the resonant frequency of the acoustic warning device (1), i.e., optimal operating point. Furthermore, acoustic warning devices (1) with an electronic control circuit are known to use a pulse generator to adjust the movement of the mobile core (3) and therefore to adjust the frequency and sound pressure of the sound generated by the acoustic warning device (1).

Different patent documents which have been able to adjust, more or less successfully, the acoustic warning device to the resonant frequency thereof have been known up until now, specifically:

Patent document U.S. Pat. No. 5,414,406A discloses an acoustic warning device or horn for vehicles including an electronic switching circuit operating at switching frequency equal to the resonant frequency. To that end, the horn has an acoustic sensor (microphone) measuring the sound pressure at the operating frequency of the horn and transmitting that information to an A/D circuit that uses it to adjust the frequency of a pulse generator energizing the coil of the horn to the working frequency.

In turn, patent document U.S. Pat. No. 7,876,198B2 discloses an electronic horn using a sensor (such as a sound sensor, an oscillation sensor, a magnetic induction sensor, or a capacitive sensor) to measure the greatest movement of the diaphragm at the operating frequency of the horn. With this measurement, an oscillating circuit is given feedback and the frequency of a pulse generator energizing the coil of the horn at the optimal working frequency, that is, the resonant frequency, is adjusted.

The translation of a European patent leading to ES2254716T3 is furthermore known, where said patent discloses an acoustic warning device that successfully dispenses with the use of sensors by means of analyzing the field current of the coil (or derivatives thereof) and comparing the measured variables with predetermined theoretical values, using to that end a frequency analyzer and a signal processor.

It has therefore been detected that while current control and adjustment systems for acoustic warning devices, as well as the aforementioned patent documents, do work at the resonant frequency, they do suffer from several drawbacks, with the following standing out:

They use “sensors” as system for measuring the operating frequency. The use of sensors in control systems entails several problems, namely: the operation thereof is affected by environmental factors, such as temperature or humidity; over time, said sensors are subjected to the inexorable degradation of their internal components; they are limited to the specific tolerances provided by each manufacturer; furthermore, the sensors are sensitive to electromagnetic compatibility (EMC) and to mechanical vibrations, which makes that solution have low robustness and a smaller scope of application.

In addition to what has been indicated in the preceding point, the use of sensors in control systems entails higher implementation complexity, and accordingly an increase in economic costs.

Other control systems require the comparison of fixed theoretical values previously programmed in the control circuit. In addition to increasing implementation complexity, this solution entails a reduction in the operating flexibility of acoustic warning devices, limiting their scope of application to a very small range of values.

They include sensing circuits that require “signal amplifiers,” also increasing the manufacturing and implementation costs.

On the other hand, current control systems for acoustic warning devices depend on a number of parameters and variables, such as the type of coil used, the operating temperatures, the mechanical characteristics, and the manufacturing tolerances, which results in a significant limitation to their scope of application, as well as a higher probability of errors, glitches, or defective operations of the warning devices.

### DESCRIPTION OF THE INVENTION

The present invention solves the drawbacks mentioned above by providing a method for controlling an acoustic warning device at the resonant frequency thereof, which constitutes a more robust, more flexible, and easier-to-implement alternative with respect to current methods for controlling acoustic warning devices.

The present invention is based on the following basic knowledge:

The variation in voltage in a coil with constant inductance is governed by the following formula:

$${U}_{L} ( t ) = L \int \frac{di ( t )}{dt} dt$$

In contrast, the variation in voltage in a coil with variable inductance is governed by the following formula:

$${U}_{L} ( t ) = \int \int \frac{dl ( t )}{dt} \frac{di ( t )}{dt} {dt}^{2}$$

where the variation in current di(t)/dt through the coil is virtually constant during the discharge/disconnection of the coil of an acoustic warning device. Therefore, it can be deduced from the foregoing that the changes in circulating voltage (U_{L}) at the disconnection end of the coil are due to variations in inductance, dl(t)/dt.

Therefore, the control method of the invention comprises the following steps: a) circulating an electric current through a variable-inductance excitation coil, generating a magnetic field; b) moving a mobile metal core as a result of the magnetic field that is generated; c) integrally moving a diaphragm connected to the mobile metal core; and d) generating a sound pressure.

The control method further comprises the steps of:

e) analyzing and measuring the variation in voltage (U_{L}) of the coil and/or at least one variable property of said voltage (U_{L}), the analysis being performed by a control circuit during the disconnection transient of the coil caused by an electronic switching device; and

f) adjusting the frequency and pulse rate of a pulse generator by means of the control circuit, where said adjustment is made according to a working condition in which a greater inductance variation is produced in the coil, that is, by adjusting the warning device to the resonant frequency thereof.

Preferably, step e) is performed during the disconnection transient of the coil, particularly at the end of the coil that is disconnected from the electric circuit. Nevertheless, it has been envisaged that said step e) can be performed at another point of the circuit where an electric effect is generated during the switching of the coil.

Therefore, a fundamental aspect of the control method described herein is that it is “during the disconnection of the coil”, and not at another time, that the control circuit analyzes the variation in voltage (U_{L}) at the end of the coil being switched due to the action of the electronic switching device. This control circuit calculates the deviations of the measured variable with respect to an optimal behavior or trend of said variable, and adjusts the frequency and pulse rate of the pulse generator energizing, that is, feeding the coil.

Said control circuit therefore adjusts the frequency and pulse rate of the pulse generator to the working condition that produces the highest inductance variation dl(t)/dt. This in turn entails the greatest movement of the mobile core with respect to the coil. The control circuit thereby adjusts the acoustic warning device to make it work at the resonant frequency thereof.

Therefore, several other advantages are obtained by means of the control method of the invention, with the following standing out:

Greater robustness and ease of implementation in control circuits of acoustic warning devices, without having to incorporate “sensors” or “signal amplifiers” that make the operation thereof more complex and tedious, or that limit their operating range due to external factors such as temperature, EMC, or vibrations. In the present invention, the actual inductance of the acoustic warning device acts as a sensor.

Greater efficacy in the detection of the optimal operating point in order to make the warning device work at its resonant frequency, without external components or sensors that distort said optimal operating point.

Greater simplicity, since the adjustment of the warning device does not require comparing the measured variables with fixed theoretical values previously programmed in the control circuit.

Greater flexibility and range of application, since the control method herein described is independent of the type of coil of the warning device, its mechanical properties, or the parameters that are characteristic of each manufacturer, such as the operating temperature.

### DESCRIPTION OF THE DRAWINGS

To complement the description that is being made and for the purpose of helping to better understand the features of the invention according to a preferred practical embodiment thereof, a set of drawings is attached as an integral part of said description in which the following is depicted with an illustrative and non-limiting character:

FIG. 1 shows a section view of the internal mechanical components of a conventional acoustic warning device with an electronic control system.

FIG. 2 shows a schematic view of a block diagram of the control method of the invention for a negative (low side) switching system.

FIG. 3 shows another block diagram of the control method of the invention for a positive (high side) switching system.

### PREFERRED EMBODIMENT OF THE INVENTION

A couple of preferred embodiments are described below in reference to the aforementioned drawings, without this description limiting or restricting the scope of protection of the present invention.

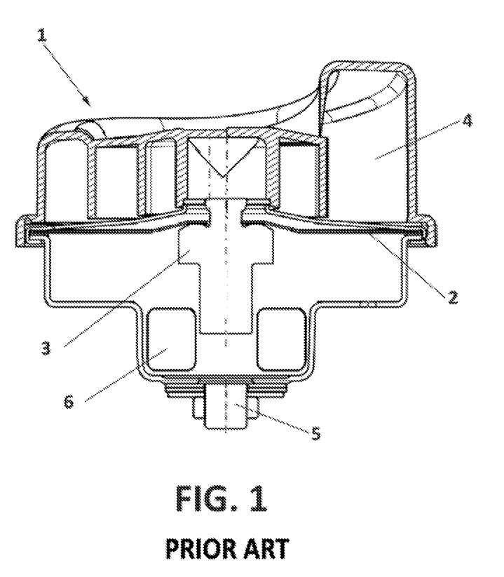

FIG. 1 depicts the basic mechanical and electrical components of a conventional acoustic warning device. In that sense, the control methods including at least the following steps are already known:

a) circulating an electric current through a coil (6), generating a magnetic field;

b) moving a mobile metal core (3) as a result of the magnetic field that is generated;

c) integrally moving a diaphragm (2) connected to the mobile metal core (3); d) generating a sound pressure.

With respect to step d) of generating a sound pressure, it has been envisaged that this sound pressure can be obtained in at least two ways:

i) from an airflow circulating through a conduit or duct (4), said airflow being created by the movement of the diaphragm (2), which makes the duct (4) vibrate; or

ii) after the movement of the diaphragm (2) on the basis of an impact between the mobile metal core (3) and a fixed core (5) of the warning device (1), as occurs in disc-shaped acoustic warning devices.

The control method of the invention therefore stands out for incorporating two additional steps:

e) analyzing and measuring the variation in voltage (U_{L}) of the coil (6) and/or at least one variable property of said voltage (U_{L}), the analysis being performed by a control circuit (10) during the disconnection transient of the coil (6) caused by an electronic switching device (20); and

f) adjusting the frequency and pulse rate of a pulse generator (30) by means of the control circuit (10), where said adjustment is made according to a working condition in which a greater inductance variation is produced in the coil (6), which corresponds with a greater movement of the mobile core (3) with respect to the coil (6), and accordingly, by adjusting the warning device (1) to the resonant frequency thereof.

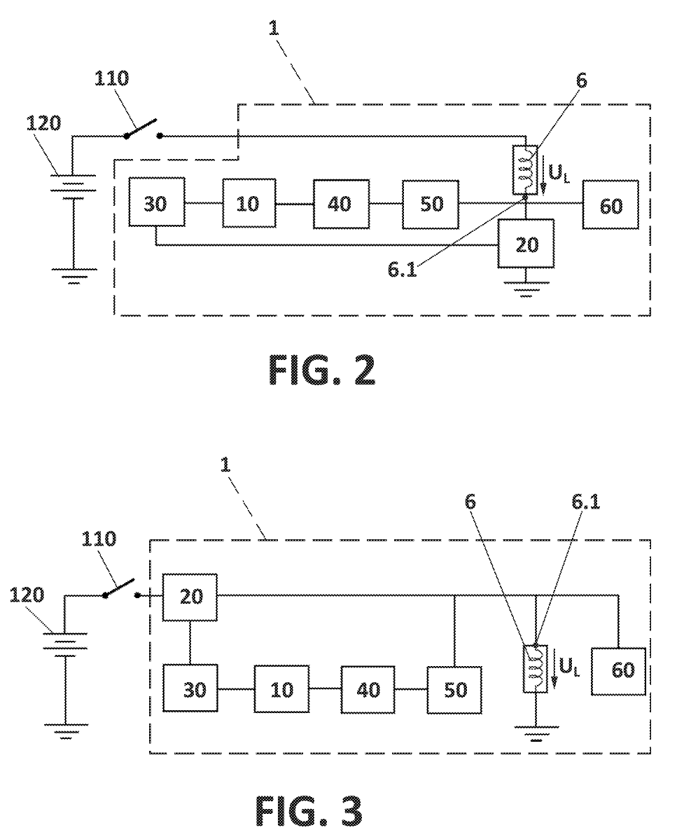

FIG. 2 shows a block diagram of the electronic control system according to a first preferred embodiment, see blocks located within the area demarcated by a dashed line, where the connection/disconnection of the coil (6) is caused by the electronic switching device (20), the latter being installed “downstream” of the coil (6) and grounded, constituting negative switching, which is perhaps better known as low side switching.

In turn, FIG. 3 shows another block diagram of the electronic control system according to a second preferred embodiment, where the connection/disconnection of the coil (6) is caused by the electronic switching device (20), the latter being installed in this case “upstream” of the coil (6) and connected to the circuit power input, constituting positive switching, which is perhaps better known as high side switching.

FIGS. 2 and 3 show that both configurations can be connected to a power supply (120), such as the battery of a vehicle, through an external switching device (110), such as through the actuation of the steering wheel of a vehicle.

It has been envisaged that the control method may comprise an additional conversion step for converting an analog voltage of the end (6.1) of the coil (6) being switched, or other voltages or currents derived from it, into a digital voltage through an A/D converter (40).

On the other hand, the control method may also comprise an additional measuring step for measuring the charging and/or discharging times of the coil (6) or times derived from this phenomenon.

Furthermore, the possibility of the method also comprising a comparison step for comparing the variation in voltage (U_{L}) of the coil (6) with target optimal conditions is contemplated, said comparison being performed from a signal processor (50), such that the result of said comparison causes the adjustment of at least one parameter for the pulse generator (30).

According to another object of the invention, protection is to be claimed for the acoustic warning device carrying out the control method described in the preceding paragraphs.

In that sense, the acoustic warning device comprises a series of mechanical elements such as a movable diaphragm (2), a mobile metal core (3), a fixed core (5), and a coil (6); as well as a control system including, in addition to a pulse generator (30), an electronic switching device (20) for disconnecting an end (6.1) of the coil (6), a control circuit (10) configured for measuring the variation in voltage (U_{L}) at the end (6.1) of the coil (6) and/or at least one variable property of said voltage (U_{L}) during the disconnection transient of the coil (6), said control circuit (10) also being suitable for adjusting the frequency and the pulse rate of the pulse generator (30) according to a working condition in which a greater inductance variation is produced in the coil (6).

It has furthermore been envisaged that the acoustic warning device (1) may comprise:

an A/D converter (40) for converting an analog voltage of the disconnected end (6.1) of the coil (6) into a digital voltage;

a signal processor (50) for comparing the variation in voltage (U_{L}) of the coil (6) with target optimal conditions, such that the result of said comparison causes the adjustment of at least one parameter for the pulse generator (30); and

a power dissipation circuit (60) as a safety element to prevent problems due to overheating and EMC.

1. A method for controlling an acoustic warning device comprising the following steps:
a) circulating an electric current through a coil, generating a magnetic field;
b) moving a mobile metal core as a result of the magnetic field that is generated;
c) integrally moving a diaphragm connected to the mobile metal core;
d) generating a sound pressure;
e) analyzing and measuring at least one selected from the group consisting of (i) the variation in voltage of the coil and at least one variable property of said voltage, the analysis being performed by a control circuit during the disconnection transient of the coil caused by an electronic switching device; and
f) adjusting the frequency and pulse rate of a pulse generator by means of the control circuit, where said adjustment is made according to a working condition in which a greater inductance variation is produced in the coil, that is, by adjusting the warning device to the resonant frequency thereof.

2. The method according to claim 1, wherein step e) is performed during one of (i) the disconnection transient of the coil at the end of the coil that is disconnected from the electric circuit; and (ii) at another point of the circuit where an electric effect is generated during the switching of the coil.

3. The method according to claim 1, further comprising a conversion step for converting an analog voltage of the end of the coil being switched, or other voltages or currents derived from it, into a digital voltage through an A/D converter.

4. The method according to claim 1 further comprising a measuring step for measuring at least one selected from the group consisting of charging times of the coil, discharging times of the coil, and times derived from this phenomenon.

5. The method according to claim 1 further a comparison step for comparing the variation in voltage of the coil with target optimal conditions, said comparison being performed from a signal processor, such that the result of said comparison causes the adjustment of at least one parameter for the pulse generator.

6. The method according to claim 1, wherein the connection/disconnection of the coil of step e) is caused by the electronic switching device, the latter being installed downstream of the coil and grounded, constituting negative switching.

7. The method according to claim 1, wherein the connection/disconnection of the coil of step e) is caused by the electronic switching device, the latter being installed upstream of the coil and connected with an external switching device powered by a power supply, constituting positive switching.

8. The method according to claim 1, wherein step d) is performed on the basis of an airflow circulating through a conduit or duct, said airflow being created by the movement of the diaphragm, which is amplified by the duct.

9. The method according to claim 1, wherein step d) is performed after the movement of the diaphragm on the basis of an impact between the mobile metal core and a fixed core of the warning device.

10. An acoustic warning device carrying out the control method described in claim 1.

11. The acoustic warning device according to claim 10, further comprising a movable diaphragm, a mobile metal core, a fixed core, and a coil; and a control system comprising a pulse generator, wherein said control system additionally comprises:
an electronic switching device for disconnecting an end of the coil; and
a control circuit configured for measuring the variation in voltage at the end of the coil and at least one variable property of said voltage during the disconnection transient of said coil, the control circuit also being suitable for adjusting the frequency and the pulse rate of the pulse generator according to a working condition in which a greater inductance variation is produced in the coil.

12. The acoustic warning device according to claim 11, further comprising an A/D converter for converting an analog voltage of the disconnected end of the coil into a digital voltage.

13. The acoustic warning device according to claim 11, further comprising a signal processor for comparing the variation in voltage of the coil with target optimal conditions, such that the result of said comparison causes the adjustment of at least one parameter for the pulse generator.

14. The acoustic warning device according to claim 11, further comprising a power dissipation circuit.
